(19) United States
(12) Patent Application Publication
(10) Pub. No.: US 2002/0071644 A1
(43) Pub. Date: Jun. 13, 2002

(54) Insulated copper wires and optical fiber composite cable

(76) Inventor: Yasuo Nakajima, Tokyo (JP)

Correspondence Address: KNOBBE MARTENS OLSON & BEAR LLP, 620 NEWPORT CENTER DRIVE, SIXTEENTH FLOOR, NEWPORT BEACH, CA, 92660, US

(21) Appl. No.: 09/965,665

(22) Filed: Sep. 25, 2001

(30) Foreign Application Priority Data
Oct. 5, 2000 (JP) 2000-306018

(51) Int. Cl. G02B 6/44

(52) U.S. Cl. 385/101; 385/103

(57) ABSTRACT

An insulated copper wires and optical fiber composite cable suited to the high bit-rate transmission of network communications is provided. A plurality of twisted pair lines (4) each of which includes one pair of insulated copper wires and in which the corresponding pairs of insulated copper wires are twisted together at lengths of lay different from each other, and a plurality of optical fibers are bunched. Each of the optical fiber is formed of a multicore type plastic optical fiber (6). The twisted pair lines (4) and the multicore type plastic optical fibers (6) are arranged in adjacency to one another. All of the twisted pair lines (4) and the multicore type plastic optical fibers (6) are twisted together to form the insulated copper wires and optical fiber composite cable (10).

### FIELD OF THE INVENTION

The present invention relates to an insulated copper wires and optical fiber composite cable which is suited to the high bit-rate transmission of network communications.

### BACKGROUND OF THE INVENTION

Cables such as a power feeder line serving also as a communication line, a telephone line, and a TV coaxial line, are used as domestic distribution cables for telecommunications. An environment where large quantities of multimedia information can be utilized even in a general home, is longed for with the rapid spread of digital contents technologies, the merger between broadcasting and communications, etc. in near future.

### SUMMARY OF THE INVENTION

The present invention provides an insulated copper wires and optical fiber composite cable which makes the utilization of multimedia information possible. The insulated copper wires and optical fiber composite cable comprises:

a plurality of twisted pair lines each of which includes one pair of insulated copper wires, and in which the corresponding pairs of insulated copper wires are twisted together at lengths of lay different from each other; and

a plurality of optical fibers;

wherein each of said optical fibers is formed of a multicore type plastic optical fiber;

said twisted pair lines and the multicore type plastic optical fibers are arranged in adjacency to one another; and

all of said plurality of twisted pair lines and the plurality of multicore type plastic optical fibers are twisted together.

### BRIEF DESCRIPTION OF THE DRAWINGS

Exemplary embodiments of the invention will now be described in conjunction with drawings in which:

FIG. 1 is a sectional view showing an insulated copper wires and optical fiber composite cable in an embodiment of the present invention;

FIG. 2 is a sectional view showing an insulated copper wires and optical fiber composite cable in another embodiment of the present invention;

FIG. 3 is a plugging chart in the case where a cable of four twisted pair lines hitherto proposed is attached to an “RJ45” modular plug;

FIG. 4 is a plugging chart showing an example in which twisted pair lines in the insulated copper wires and optical fiber composite cable of the present invention are attached to the “RJ45” modular plug;

FIG. 5 is a conceptual view showing an example in which plastic optical fibers in the insulated copper wires and optical fiber composite cable of the present invention are attached to connectors for the plastic optical fibers;

FIG. 6 is a conceptual view showing an example in which the twisted pair lines in the insulated copper wires and optical fiber composite cable of the present invention are attached to the “RJ45” modular plugs;

FIG. 7 is a sectional view showing an insulated copper wires and optical fiber composite cable in still another embodiment of the present invention;

FIG. 8 is a graph showing bending loss characteristics in the embodiment shown in FIG. 7, by a solid line;

FIG. 9 is a sectional view showing a twisted pair line cable of four-pair configuration in the prior art;

FIG. 10 is a sectional view showing a cable of plastic optical fibers proposed by the inventors before; and

FIG. 11 is a sectional view showing an example of construction of a multicore type plastic optical fiber which is used in the insulated copper wires and optical fiber composite cable according to the present invention.

### Detailed Description

The data transmissions (10 Mbps and 100 Mbps) of Ethernets of standards 10BASE-T and 100BASE-T are in practice by utilizing the three types of cables of a power feeder line, a telephone line and a TV coaxial line which are already distributed in a home. In addition to the data transmissions having actual results, a data transmission standard such as “IEEE 1394”, which can realize a network having a transmission capability for the real time information of voices, pictures etc., is recently deemed promising.

In the present-day Ethernet, a four-pair cable (employing four twisted pair lines) called “Category5 (Cat.5) Cable” as shown in FIG. 9 is used as a cable for the high bit-rate transmission up to lOOMbps. Here, numeral 1 designates a conductor which is made of copper wire or the like, numeral 2 an insulator such as polyolefinic thermoplastic resin, with which the conductor 1 is coated, numeral 3 an insulated copper wire which consists of the conductor 1 and the insulator 2, numeral 4 the twisted pair line which is constructed by twisting the two insulated copper wires 3 together, and numeral 5 a jacket which is made of polyvinyl chloride or the like.

The individual twisted pair lines 4 differ in the length of lay of the insulated copper wires 3 from one another. The four-pair cable has the standard values of a characteristic impedance, a near end crosstalk, an attenuation, etc. set by ISO/IEC and EIA/TIA. The performance of the cable is guaranteed by conforming to the standard values.

The transmission standard IEEE 1394 is aimed at a multimedia interface which can be used in both an AV equipment and a personal computer, and it is a standard proposed as “IEEE 1394-1995” by IEEE (The Institute of Electrical and Electronics Engineers, Inc.). The standard also contains stipulations about a cable structure and a cable performance, and a bunch strand which consists of two shielded twisted pair lines and a two-core power feeder line is standardized as a cable. The propagation velocity and propagation distance of the cable are respectively stipulated to be up to 400 Mbps and at most 4.5 m.

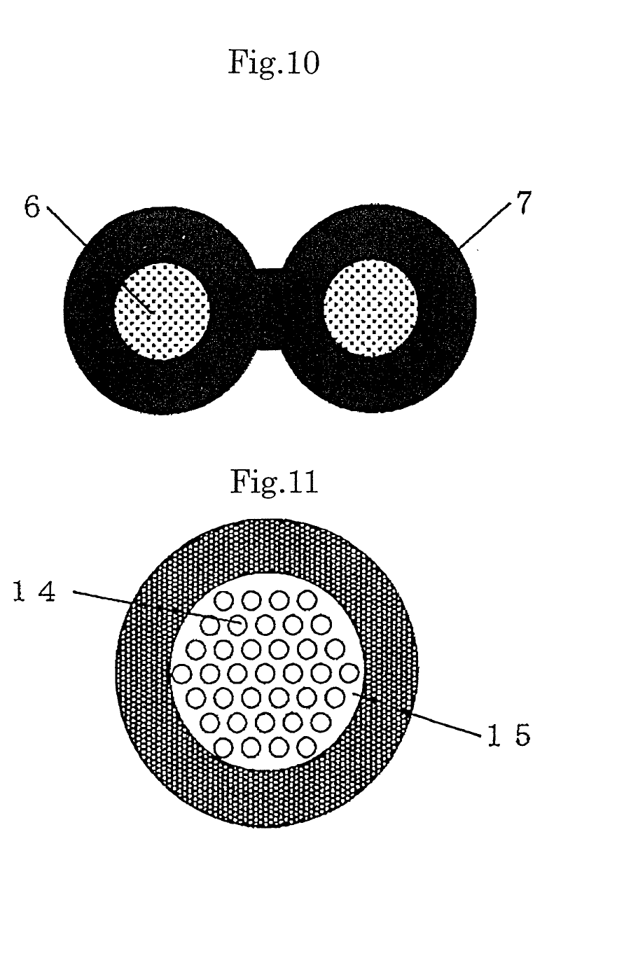

Nowadays, it is studied for complementing the standard IEEE 1394-1995 to further heighten the propagation velocity and prolong the propagation distance. As a potential transmission medium which supports “IEEE 1394B” (Draft Standard for a High Performance Serial Bus), THE FURUKAWA ELECTRIC CO., LTD. being the assignee of the present invention has already proposed an optical cable as shown in FIG. 10, in which two plastic optical fibers (POFS) are bunched into two core.

Referring to FIG. 10, numeral 6 designates the plastic optical fiber, and numeral 7 a covering layer which covers the two plastic optical fibers 6 and holds them with a spacing therebetween in the shape of spectacles. The POF 6 is constructed of a core layer of high refractive index, and a clad layer of low refractive index surrounding the core layer.

In order to cope with the two schemes of the Ethernet transmission scheme and a transmission scheme employing optical fibers, which will form the mainstreams of a home network in the future, corresponding transmission media need to be respectively laid as preceding wiring lines in each home.

In the present circumstances, equipment conforming to the standard IEEE 1394 are under development and have not reach the stage of wide use yet. It is considered that the equipment will be required as the backbone of the home network in considerably remote future. In contrast, a home Ethernet has already begun to be introduced as a home LAN (Local Area Network) for the purpose of sharing a printer etc.

It is called “FTTH” (Fiber To The Home) to lay a distribution cable of optical fibers even in the general home. Regarding the FTTH, in the State of Japan, the completion of the laying of the optical fiber cables throughout the land had been targeted at 2010, but the target year was put forward to 2005 in the “Basic Law on the Formation of an Advanced Information and Telecommunications Network Society” revised in October 1998, and so forth. In the Basic Law, it is clearly stated that efforts ought to be made for the earliest possible realization of the nationwide laying of the optical fiber cables. In this manner, the importance of the FTTH is recognized again, and the construction of optical fiber networks is expected to be expedited more from now on also in the United States, Germany etc. other than Japan.

In case of considering the information-oriented wiring in the home, the life of a house needs to be taken into consideration. The life of an independent house was said to be about 30 years. Recently, however, the life of the house has been lengthened more, and even what is called a “100-year house” has been developed. Since, however, the transmission speed will become higher and higher from now on as stated before, the existing wiring might fail to conform to the transmission speed. Therefore, the wiring in the home will have to be replaced with new wiring. In this regard, the wiring is usually embedded in walls, and this poses such problems in the execution of work that the new wiring must be laid after destroying the walls.

Accordingly, wiring is wished for which can cope with the high transmission speed in the near future and even to the still higher transmission speed in the future, and which will not have to be replaced with new one when applications conforming to the standard IEEE 1394 have come into wide use.

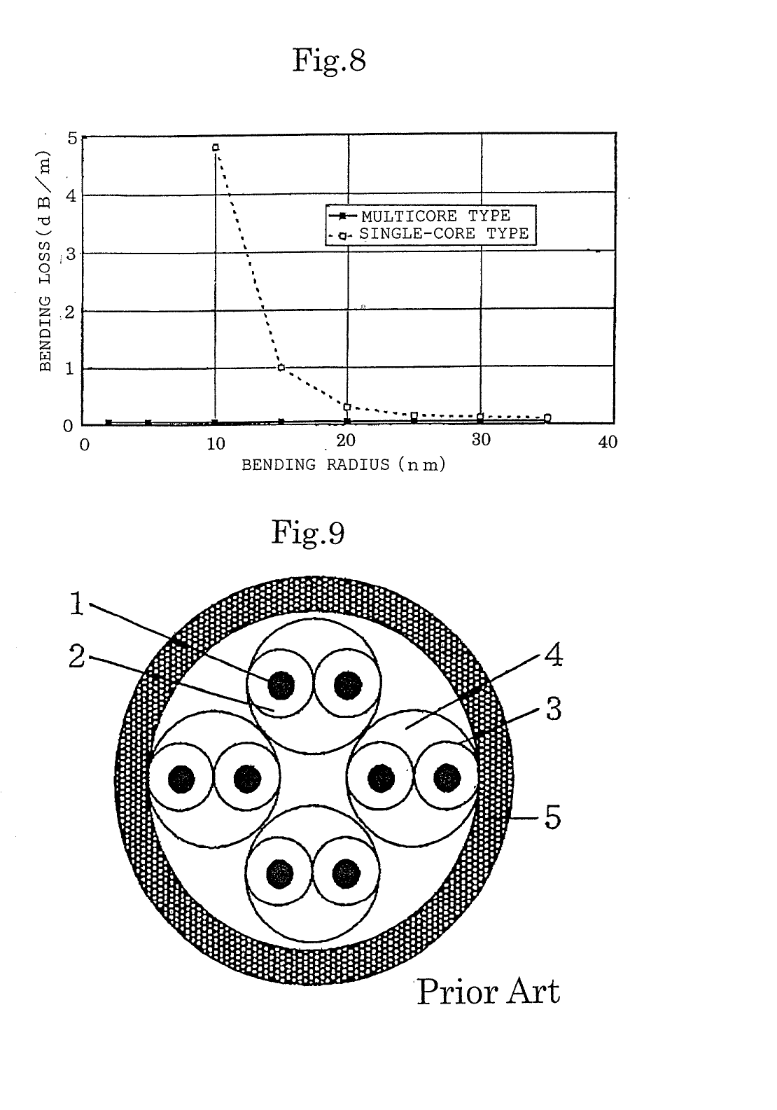

The wiring for networking in the independent house requires a flexible laying property with respect to the expansion of equipment and the alteration of layout. In this regard, an optical fiber of single core type generally used in the home exhibits a large bending loss as indicated by a broken line in FIG. 8. Therefore, unless the wiring is laid with scrupulous care in the execution of work, the bending loss enlarges.

Besides, in case of combining an optical fiber with a metal cable, it becomes a problem that the loss of the optical fiber is enlarged by forming a twisted pair.

In the standard 10BASE-T or 100BASE-T, among the four twisted pair lines constituting the category5 UTP cable, only two are actually employed for the transmission and reception of signals, and the remaining two are not used. Besides, the two optical fibers are employed for transmitting the data of the standard IEEE 1394 by the POFs (plastic optical fibers).

In future gigabit (1000BASE-T) transmission, it is foreseen that the four twisted pair lines (four-pair cable) will be used. Usually, the transmission scheme is called “Gigabit Ethernet”.

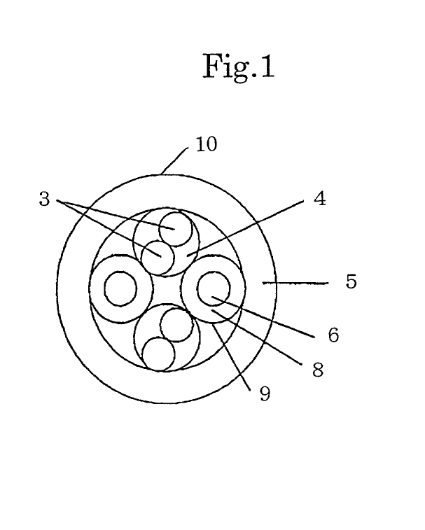

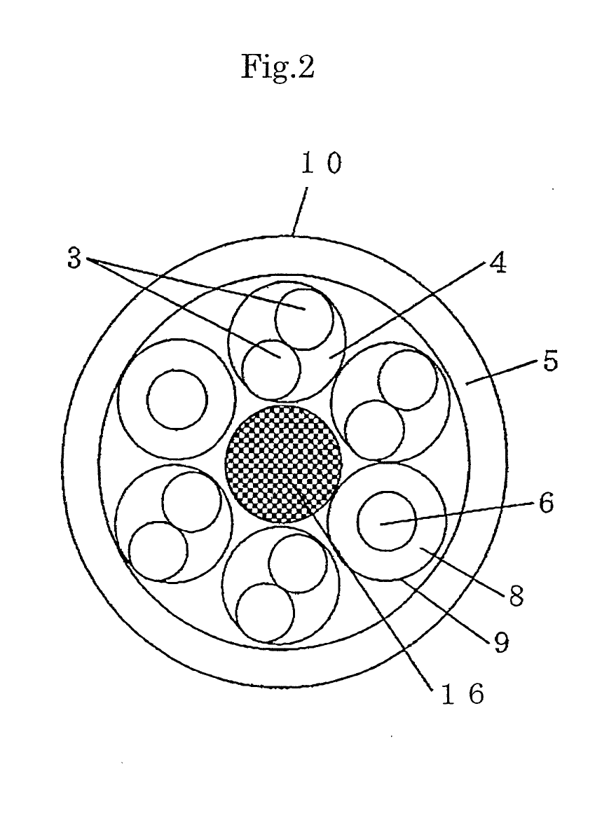

An insulated copper wires and optical fiber composite cable in one aspect of the present invention alleviates the problems stated above. Shown in FIGS. 1 and 2 are examples of structures of insulated copper wires and optical fiber composite cables according to the present invention.

FIG. 1 exemplifies the insulated copper wires and optical fiber composite cable in which two twisted pair lines 4 and two multicore type plastic optical fibers (POFS) 6 are bunched. Each of the twisted pair lines 4 includes two (one pair of) insulated copper wires 3 twisted together, and the lengths of lay of the two twisted pair lines 4 are different. The twisted pair lines 4 and the multicore type POFs 6 are arranged in adjacency to each other. In the example of FIG. 1, the multicore type POFs 6 are arranged on both the adjacent sides of each twisted pair line 4, so that the two twisted pair lines 4 do not adjoin each other. In addition, all of the twisted pair lines 4 and the multicore type POFs 6 are twisted together.

As shown in FIG. 11, each of the multicore type POFs 6 is so constructed that, within a clad 15, a plurality of cores 14 higher in the refractive index than the clad 15 are sporadically arranged. Polystyrene, polymethylmethacrylate, or the like being highly transparent is employed as a plastic which constitutes the optical fiber 6. In this embodiment, the outside diameter of the multicore type POF 6 is equal to a single-core type POF in the prior art. Since the individual cores of the multicore type POF 6 are included in large numbers within this optical fiber 6, the diameter of each individual core is much smaller as compared with that of the core of the prior-art single-core type POF. As a result, the multicore type POF 6 specified here can effect optical transmission of small bending loss.

By the way, in FIG. 1, numeral 8 designates a covering layer which covers the outer periphery of the multicore type POF 6. The covering layer 8 is formed on the outer periphery of the multicore type POF 6 in this manner, whereby a POF cable 9 is constructed. Besides, numeral 5 designates a jacket, and numeral 10 the insulated copper wires and optical fiber composite cable.

The insulated copper wires and optical fiber composite cable shown in FIG. 2 has the structure in which an interstitial line 16 is centrally arranged, and in which four twisted pair lines 4 and two multicore type plastic optical fibers (POFS) 6 are arranged around the interstitial line 16. The individual twisted pair lines 4 each including one pair of (two) insulated copper wires 3 have their insulated copper wires 3 twisted together at different lengths of lay. In addition, all of the four twisted pair lines 4 and the two multicore type POFs 6 are twisted together and bunched. Also in the insulated copper wires and optical fiber composite cable shown in FIG. 2, the multicore type POF 6 is arranged in adjacency to the twisted pair line 4.

By the way, in FIG. 2, the same reference numerals are assigned to the same constituents as in FIG. 1.

The insulated copper wires and optical fiber composite cable of the construction shown in FIG. 1 or FIG. 2 can naturally be used in the present-day transmission system, and can cope with the transmission system in the near future. Further, the insulated copper wires and optical fiber composite cable shown here can cope even with the transmission system of higher transmission speed in the future. Accordingly, the cable laid will not have to be replaced with a new one when applications conforming to the standard IEEE 1394 have come into wide use.

Besides, wiring for networking in an independent house or the like is anticipated to require a flexible laying property with respect to the expansion of equipment and the alteration of layout. Usually, in case of combining a plastic optical fiber of single core with a metal cable, the loss of the optical fiber is enlarged by being twisted together. Using the multicore type plastic optical fiber, however, increase in the loss of the optical fiber attributed to the twisting operation in the formation of the cable can be substantially nullified, and increase in the bending loss of the optical fiber at the end part thereof can be substantially nullified. Besides, notwithstanding that a small bending radius is required for the wiring in the house, the bending loss of the optical fiber is hardly increased. Therefore, the transmission characteristics of the optical fiber do not worsen after the execution of cable laying, and the cable laid can maintain good transmission characteristics.

In the standard 10BASE-T or 100BASE-T, among the four twisted pair lines 4 constituting the category 5 UTP cable as shown in FIG. 9, only two are actually employed for the transmission and reception of signals, and the remaining two are not used. In the future gigabit (1000BASE-T) transmission, it is foreseen that the four twisted pair lines 4 will be used. Besides, the two optical fibers are employed for transmitting the data of the standard IEEE 1394 by the POFs.

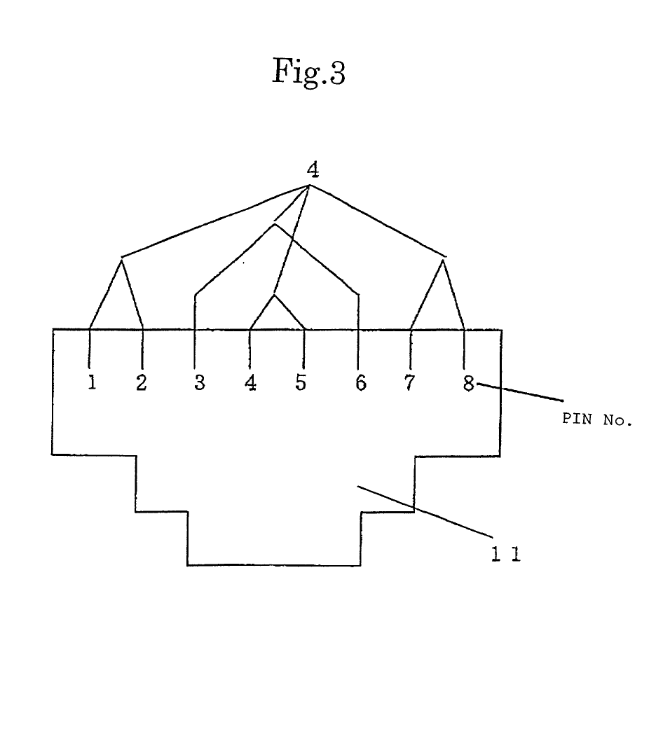

Heretofore, a modular plug/jack “RJ45” has been ordinarily attached to the four-pair cable of the category5 standard in order to construct the wiring system of the standard 10BASE-T or 100BASE-T. In this case, as shown in FIG. 3, the twisted pair lines 4 are respectively associated with the pin Nos. 1-2, 3-6, 4-5, and 7-8 of the modular plug or jack 11.

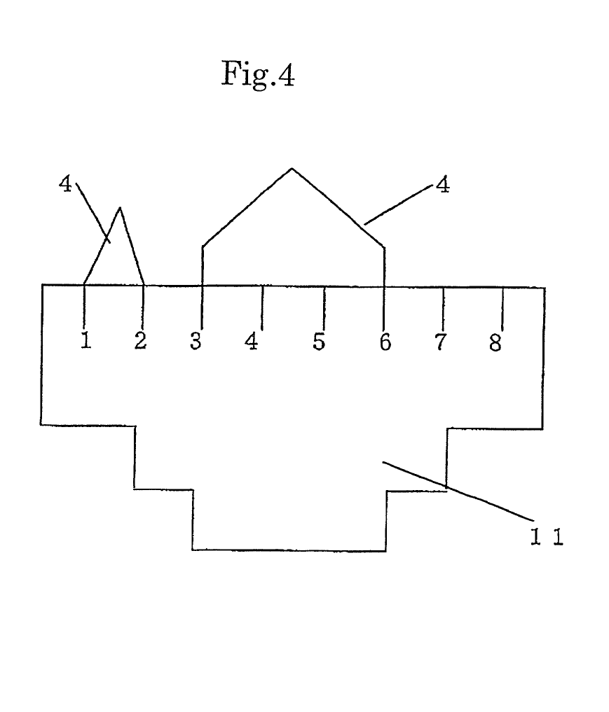

Accordingly, the insulated copper wires and optical fiber composite cable of the present invention is attached to the 8-pin modular plug or jack in conformity with the category5 standard, as follows: As shown in FIGS. 4 and 6, one pair of copper wires 3 of any of the twisted pair lines 4 are allotted to the pin Nos. 1-2 of the modular plug or jack 11, while one pair of copper wires 3 of another of the twisted pair lines 4 are allotted to the pin Nos. 3-6. On this occasion, the two POFs 6 are subjected to the end treatment of cutting or the like so as not to hamper the attachment.

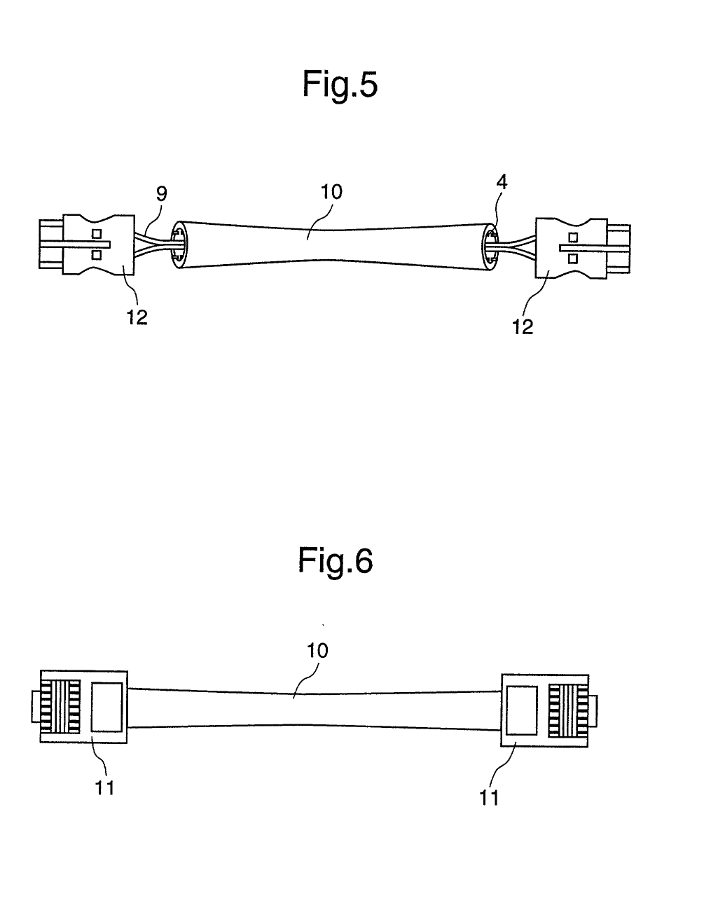

Besides, in using the insulated copper wires and optical fiber composite cable of the present invention for the standard IEEE 1394, as shown in FIG. 5, the two multicore type POF cables 9 are spliced to connectors (PN connectors) 12, and the twisted pair lines 4 are subjected to the end treatment of cutting or the like.

Thus, even if the home network is shifted from the Ethernet to the standard IEEE 1394 or comes to employ both of them in the future, the insulated copper wires and optical fiber composite cable 10 of this embodiment laid will be capable of coping with any situation by performing the end treatment.

Besides, crosstalk which occurs between the twisted pair lines 4 needs to be lessened as far as possible. Therefore, in the case where the two multicore type POF cables 9 and the two twisted pair lines 4 are twisted together as shown in FIG. 1, the multicore type POF cables 9 are arranged on both the adjacent sides of each of the two twisted pair lines 4, and the bunch strand is formed so as to avoid the adjoining touch between the twisted pair lines 4, whereby the crosstalk between the twisted pair lines 4 can be lowered.

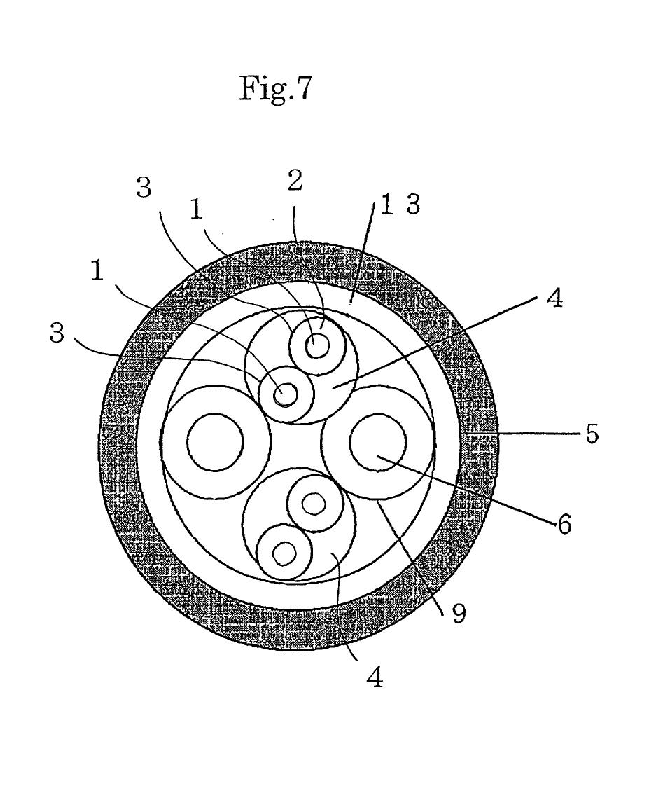

Shown in FIG. 7 is a more practicable example of an insulated copper wires and optical fiber composite cable according to the present invention. Referring to the figure, a conductor wire 1 (0.51 mm in diameter) is coated with an insulator 2 of polyolefinic resin, thereby to form an insulated copper wire 3 (0.94 mm in diameter). Two such insulated copper wires 3 are twisted on each other, thereby to form a twisted pair line 4. Two such twisted pair lines are so formed that the corresponding pairs of insulated copper wires 3 are twisted together at lengths of lay different from each other.

The two twisted pair lines 4, and two plastic optical fiber (POF) cables 9 each having a fiber diameter of 1.00 mm and a chord diameter of 2.20 mm, are formed into a bunch strand. After the formation of the bunch strand, a polyester tape 13 is pressedly wound in order to prevent the strand from collapsing. Further, the outer periphery of the polyester tape 13 is covered with a polyvinyl chloride material as a jacket 5.

A bending loss in the insulated copper wires and optical fiber composite cable is indicated by a solid line in FIG. 8. It has been verified that almost no bending loss occurs as seen from FIG. 8.

As described above, when the insulated copper wires and optical fiber composite cable in any of the embodiments is laid in the home or the like beforehand, the connectors for the standard IEEE 1394 or the connectors (modular plugs/jacks) for the Ethernet can be attached to the ends of the cable as may be needed.

Therefore, the insulated copper wires and optical fiber composite cable can be used as the transmission medium of the Ethernet of, e.g., the standard 10BASE-T for the time being by splicing the connectors to the two twisted pair lines of the cable. Besides, if the data and picture transmission based on the standard IEEE 1394 becomes necessary in the future, the insulated copper wires and optical fiber composite cable will be usable as a transmission medium conforming to the IEEE 1394 network, by detaching the connectors from the twisted pair lines and attaching the connectors for the POF cables to the two POF cables, respectively.

Incidentally, the insulated copper wires and optical fiber composite cable of the present invention is not restricted to the foregoing embodiments. The materials of the constituents constituting the insulated copper wires and optical fiber composite cable, the numbers of the twisted pair lines 4 and the multicore type plastic optical fibers 6, the structure of the cable, etc. are variously alterable within the scope not departing from the spirit of the invention as defined in the appended claims.

What is claimed is:

1. An insulated copper wires and optical fiber composite cable comprising:
a plurality of twisted pair lines each of which includes one pair of insulated copper wires, and in which the corresponding pairs of insulated copper wires are twisted together at lengths of lay different from each other; and
a plurality of optical fibers;
wherein each of said optical fibers is formed of a multicore type plastic optical fiber;
said twisted pair lines and the multicore type plastic optical fibers are arranged in adjacency to one another; and
all of said plurality of twisted pair lines and the plurality of multicore type plastic optical fibers are twisted together.

2. An insulated copper wires and optical fiber composite cable according to claim 1, wherein:
the number of said twisted pair lines included in said cable is either of two and four;
the number of said multicore type plastic optical fibers is two; and
all of said twisted pair lines and all of said multicore type plastic optical fibers are twisted together and bunched.

3. An insulated copper wires and optical fiber composite cable according to claim 1, wherein:
the number of said twisted pair lines included in said cable is two;
the number of said multicore type plastic optical fibers is two;
said multicore type plastic optical fibers are arranged on both adjacent sides of each of said twisted pair lines, thereby to avoid adjoining arrangement between said twisted pair lines; and
all of said twisted pair lines and all of said multicore type plastic optical fibers are twisted together and bunched.
